(19) United States
(12) Patent Application Publication
(10) Pub. No.: US 2006/0157179 A1
(43) Pub. Date: Jul. 20, 2006

(54) Pneumatic tire

(76) Inventors: Kensuke Bito, Osaka-shi (JP); Tetsuji Miyazaki, Osaka-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/331,911

(22) Filed: Jan. 16, 2006

(30) Foreign Application Priority Data
Jan. 17, 2005 (JP) 2005-009113
Jan. 19, 2005 (JP) 2005-011117

(51) Int. Cl. B60C 11/00

(52) U.S. Cl. 152/209.19; 152/209.17

(57) ABSTRACT

A pneumatic tire having a tread surface formed with a groove portion includes a bag-like groove. The bag-like groove includes a groove head portion having a partially opened substantially loop-like inner wall, and a groove neck portion which is in communication with the opening of the groove head portion through a groove width smaller than a maximum groove width of the groove head portion. The groove head portion of the bag-like groove is formed with a projection rising from a groove bottom surface.

### BACKGROUND OF THE INVENTION

1. Field of the Invention

The present invention relates to a pneumatic tire capable of reducing pumping sound generated due to a groove portion formed in a tread surface.

2. Description of the Related Art

A tread surface of a pneumatic tire is formed with various tread patterns in accordance with using conditions. Among them, in the case of a pneumatic tire in which fashion is paramount, a tread pattern having such a shape that not only enhances the tire performance but also visually presents a beautiful sight. There are various tread patterns which can enhance the fashion, and groove portion and land portions of various shapes are formed in a tread surface.

FIG. 6 is a perspective view showing one example of a tread surface of a pneumatic tire in which such fashion is paramount, and a portion of a groove portion is shown in enlarged scale. Usually, a groove portion formed in the tread surface is formed such that the groove width is constant or the groove width is gradually reduced or increased. In the case of a groove portion shown in FIG. 6, however, the groove portion is formed into a bag shape in which the groove width is locally increased at its end. Such a bag-like groove 23 includes a groove head portion 17 having a substantially loop-like partially opened inner wall 16, and a groove neck portion 18 which is in communication with an opening of the groove head portion 17 through a groove width smaller than a maximum groove width of the groove head portion 17.

The present inventors researched concerning a tread surface formed with such a bag-like groove, and found the following facts. That is, in the case of the tread surface formed with the above-described bag-like groove, a substantially closed space is formed between the groove head portion 17 and a road surface, compressed air in the substantially closed space is abruptly discharged out through the narrow groove neck portion 18, thereby generating pumping sound, and noise-reducing performance is deteriorated. To reduce the pumping sound, it is conceived that the groove width of the groove head portion 17 is reduced or the groove width of the groove neck portion 18 is increased so that air can smoothly move. In the case of a pneumatic tire in which fashion is paramount, however, a range where the groove width is secured is limited in some cased in terms of design, and this method can not always be employed.

Japanese Patent Application Laid-open No. H6-48119 discloses a pneumatic tire capable of enhancing the noise-reducing performance by providing a groove bottom with a projection. According such a pneumatic tire, however, the columnar projection provided in the vicinity of an opening end of a lateral groove blocks air passing through the lateral groove, thereby reducing columnar resonance generated when the compressed air is abruptly discharged out through the lateral groove. Thus, this technique does not reduce the pumping sound as the above-described bag-like groove.

Japanese Patent Application Laid-open No. 2004-155335 discloses a pneumatic tire in which ends of lug grooves are connected to each other through a thin groove. According to such a pneumatic tire, however, ends of lug grooves separated from each other through a tire equatorial plane are brought into communication with each other through the deep thin groove, thereby suppressing shearing deformation generated in a tread rubber and preventing cut separation, and this technique can not reduce the pumping sound as the bag-like groove.

### SUMMARY OF THE INVENTION

It is an object of the present invention to provide a pneumatic tire capable of reducing pumping sound generated due to a bag-like groove formed in a tread surface.

The object can be achieved by the present invention. That is, the invention provides a pneumatic tire having a tread surface formed with a groove portion, wherein the groove portion comprises a bag-like groove having a groove head portion where the groove portion has a substantially loop-like partially opened inner wall, a groove neck portion which is in communication with the groove head portion through a groove with smaller than a maximum groove width of the groove head portion, the groove head portion of the bag-like groove is formed with a projection rising from a groove bottom surface.

According to the structure of the present invention, since the projection rising from the groove bottom surface is formed on the groove head portion of the bag-like groove, it is possible to reduce a substantially closed space formed between the groove head portion and a road surface during running, and to reduce the volume of air discharged out through the groove neck portion. There is also another effect that the vibration of air in the substantially closed space is absorbed by the projection. As a result, the pumping sound generated due to the bag-like groove can effectively be reduced, and the noise-reducing performance can be enhanced. Further, the pumping sound can be reduced without changing the groove width of the bag-like groove and thus, the invention can preferably be applied to a pneumatic tire in which fashion is paramount.

In the above pneumatic tire, it is preferable that when a cross section of the groove neck portion in which a groove cross-sectional area becomes minimum is defined as a minimum cross section, a relation between a groove cross-sectional area S (mm²) in the minimum cross section and a groove volume V (mm³) from the minimum cross section closest to the groove head portion to the groove head portion when the projection is not formed is V/S≧25.

The present inventors researched concerning the tread surface formed with the bag-like groove to effectively achieve the above object, and paid attention to the relation between a groove volume of the groove head portion and the groove cross-sectional area of the groove neck portion, and obtained a result shown in a graph in FIG. 7 using a method shown in the embodiment. A horizontal axis of this graph shows a ratio V/S of the groove cross-sectional area S (mm²) in the minimum cross section and the groove volume V (mm³) from the minimum cross section closest to the groove head portion to the groove head portion when the projection is not formed. A vertical axis shows a noise level at the time of running.

According to FIG. 7, it can be found that as the V/S is greater, volume per a groove cross-sectional area of air passing through the groove neck portion is increased and thus, the noise level is increased. It was found that especially when the V/S was 25 or higher, the noise level exceeded a practically permissible range. In this structure, the bag-like groove where the pumping sound is seriously generated is provided with the projection capable of reducing the pumping sound, and the structure of the invention is especially effective.

Here, the term “cross section of the groove neck portion” means a cross section intersecting with an extending direction of the groove neck portion. Further, the term “groove volume when the projection is not formed” means a groove volume calculated using a groove bottom surface when the groove head portion is not formed with the projection, or the like.

In the pneumatic tire, it is preferable that when a cross section of the groove neck portion in which a groove cross-sectional area becomes minimum is defined as a minimum cross section, a relation between a surface area a (mm²) of the projection and a groove surface area A (mm²) from the minimum cross section closest to the groove head portion to the groove head portion when the projection is not formed is 0.01≦a/A≦0.5.

According to the structure, the projection with respect to the groove head portion can have an appropriate size in view of the noise-reducing performance and the draining performance. That is, if the a/A is less than 0.01, there is a tendency that the effect that the vibration of air in the substantially closed space formed between the groove head portion and a road surface is absorbed by the projection is reduced. If the a/A exceeds 0.5, since the size of the projection with respect to the groove head portion is increased, there is a tendency that the draining performance is deteriorated. Thus, according to the above structure, it is possible to effectively reduce the pumping sound while securing the draining performance.

Here, the term “groove surface area” is an area of the groove bottom surface and the inner wall surface. The term “groove surface area from the minimum cross section to the groove head portion when the projection is not formed” means an area calculated from the groove bottom surface, the inner wall surface and the groove cross-sectional area of the minimum cross section when the groove head portion is not formed with the projection.

In the pneumatic tire, it is preferable that the projection is formed with a step. With this, the surface area of the projection can be increased, and it is possible to enhance the effect that the vibration of air in the substantially closed space formed between the groove head portion and the road surface is absorbed during running.

In the pneumatic tire, it is preferable that the groove head portion is provided with a connecting portion which connects the projection and the inner wall of the groove head portion to each other. With this, the volume of air in the substantially closed space formed between the groove head portion and the road surface is reduced, the rigidity of the projection is enhanced, and the absorbing effect of air in the substantially closed space can be enhanced.

In the pneumatic tire, it is preferable that a relation between a land portion height d (mm) of the projection and a land portion height D (mm) of a block is 0.15≦d/D≦0.75. With this, the substantially closed space can be reduced and the pumping sound can be reduced as described above, and the draining performance in the bag-like groove can be secured.

In the pneumatic tire, it is preferable that the tire further comprises a connecting groove which connects a groove or a grounding end which is adjacent to the bag-like groove through the land portion and the groove head portion of the bag-like groove to each other. With this, air in the substantially closed space formed between the groove head portion and the road surface is dispersed from both of the groove neck portion and connecting groove and discharged out. As a result, pressure of air discharged through the groove neck portion is reduced and thus, the pumping sound can be reduced more effectively.

Here, the term “grounding end” means an outermost position of the tire in its axial direction which comes into contact with a flat road surface when the tire is assembled to a normal rim, the tire is placed perpendicular to the flat surface in a state in which normal internal pressure is charged into the tire and a normal load is applied to the tire. The normal load and the normal internal pressure are the maximum load (design load when the tire is for a passenger vehicle) defined in JISD4202 (specification of automobile tire) or the like and air pressure suitable for the maximum load, and the normal rim is a standard rim defined in JISD4202 or the like in principle.

In the pneumatic tire, it is preferable that when the cross section of the groove neck portion where the groove cross-sectional area becomes minimum is defined as the minimum cross section, a groove width of the connecting groove is equal to or smaller than a groove width of the minimum cross section and equal to or larger than 2 mm. With this, since the connecting groove is inconspicuous on the tread surface and the fashion is not deteriorated, this feature can be employed for a pneumatic tire in which fashion is paramount. Since the groove width is set to 2 mm or wider, when the tire comes into contact with the ground, the groove width of the connecting groove can be secured, and the reducing effect of the pumping sound can effectively be secured.

In the pneumatic tire, it is preferable that a groove depth of the connecting groove is equal to or larger than 20% of a groove depth of the groove head portion. With this, a constant or more volume of air discharged through the connecting groove is secured, and the reducing effect of the pumping sound is effectively secured.

### BRIEF DESCRIPTION OF THE DRAWINGS

FIG. 1 is a sectional view of a tire meridian showing one example of a pneumatic tire according to the present invention;

FIG. 2 is a plan view showing an example of a tread surface of the pneumatic tire of the invention;

FIG. 3a is a perspective view of a bag-like groove;

FIG. 3b is a plan view of the bag-like groove;

FIG. 3c is a sectional view taken along the line C-C in FIG. 3b;

FIG. 4a is a perspective view of a bag-like groove of another embodiment;

FIG. 4b is a plan view of a bag-like groove of another embodiment;

FIG. 5 is a graph showing an evaluation result of a noise-reducing performance;

FIG. 6 is a perspective view showing an example of the bag-like groove; and

FIG. 7 is a graph showing a relation between a groove volume of a groove head portion and a groove cross-sectional area of a groove neck portion.

### DESCRIPTION OF THE PREFERRED EMBODIMENTS

Preferred embodiments of the present invention will be explained with reference to the drawings.

### First Embodiment

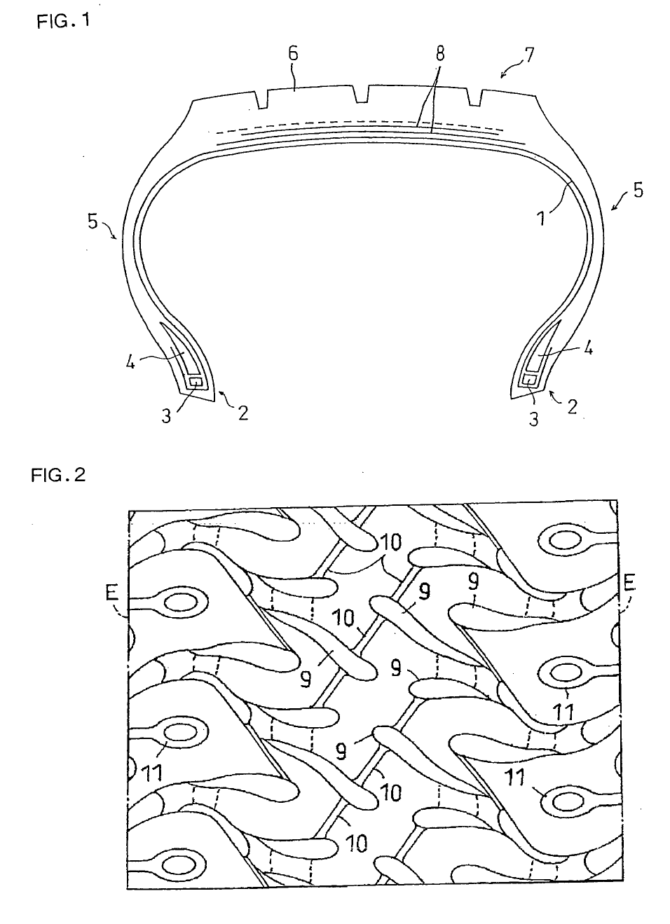

A pneumatic tire of the present invention has the same tire structure as that of the conventional tire except a tread surface, and is the same as that shown in FIG. 1 for example.

The pneumatic tire shown in FIG. 1 includes a pair of annular bead portions 2, sidewall portions 5 extending from the bead portions 2 toward outer peripheral side of the tire, and a tread portion 7 connected to the outer peripheral ends of the sidewall portions 5 through shoulder portions. A carcass ply 1 is provided between the bead portions 2, and rolled up at ends to catch beads 3 and a bead filler 4. One or more belt layers 8 are disposed on the outer side of the carcass ply 1 of the tread portion 7, and a belt reinforcing layer is disposed if necessary. A tread rubber is disposed on the belt layer 8 on the outer peripheral side of the tire. Various tread patterns are formed on tread surface 6 in accordance with required tire performance and using condition.

Examples of raw material rubbers for the rubber layer and the like are natural rubber, styrene-butadiene rubber (SBR), butadiene rubber (BR), isoprene rubber (IR) and butyl rubber (IIR), which may be used alone or in combination therewith.

These rubbers are reinforced using filler such as carbon black and silica, and vulcanizing agent, vulcanizing accelerator, plasticizer, antioxidant or the like is appropriately mixed.

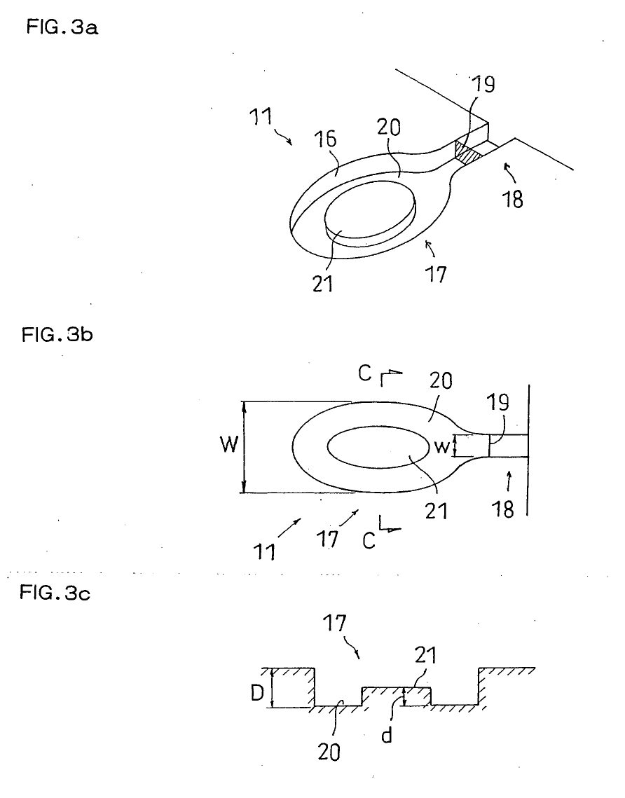

The tread surface of the pneumatic tire according to the present invention will be explained. FIG. 2 is a plan view showing one example of the tread surface of the pneumatic tire. FIG. 3a is a perspective view of a bag-like groove. FIG. 3b is a plan view of the bag-like groove. FIG. 3c is a sectional view taken along the line C-C in FIG. 3b.

The tread pattern formed on the tread surface 6 of the embodiment is so-called a block type pattern. The tread pattern includes a groove portion and a plurality of land portions (blocks) divided by the groove portion. The groove portion of the embodiment includes lateral grooves 9 extending from an outer side of the tire in its widthwise direction toward a center of a tread surface 6 while curving, a thin groove 10 extending such as to connect the lateral grooves 9 to each other such as to incline with respect to the circumferential direction of the tire, and a lug groove 11 (corresponding to the bag-like groove, and will be called bag-like groove 11, hereinafter) formed into a bag-like shape which is opened at a tread edge E and whose groove width is locally increased at its end.

As shown in FIGS. 3a and 3b, the bag-like groove 11 includes a groove head portion 17 having a substantially loop-like partially opened, and a groove neck portion 18 which is in communication with the opening of the groove head portion 17 through a groove width smaller than a maximum groove width W of the groove head portion 17. The minimum cross section 19 is a cross section in which a groove area when the minimum cross section 19 crosses the groove neck portion 18 becomes minimum. Thus, a groove width w of the minimum cross section 19 is smaller than the maximum groove width W of the groove head portion 17, and the maximum groove width W is set to 1.2 times or more of the groove width w.

The groove head portion 17 of the bag-like groove 11 is formed with a projection 21 rising from a groove bottom surface 20. With this, a substantially closed space formed between the groove head portion 17 and a road surface becomes small at the time of running, and it is possible to reduce the volume of air compressed and discharged in the space. As a result, it is possible to effectively reduce the pumping sound caused by the bag-like groove 11.

It is preferable that a relation between a land portion height d (mm) of the projection 21 and a land portion height (groove depth of the groove head portion 17) D (mm) of the block is 0.15≦d/D≦0.75, and more preferably 0.2≦d/D≦0.6. If the relation d/D is less than 0.15, the reducing effect of the substantially closed space is poor, and there is a tendency that the pumping sound reducing effect becomes poor. If the relation d/D exceeds 0.75, the land portion height of the projection 21 is too high and there is a tendency that the draining performance in the bag-like groove 11 is deteriorated.

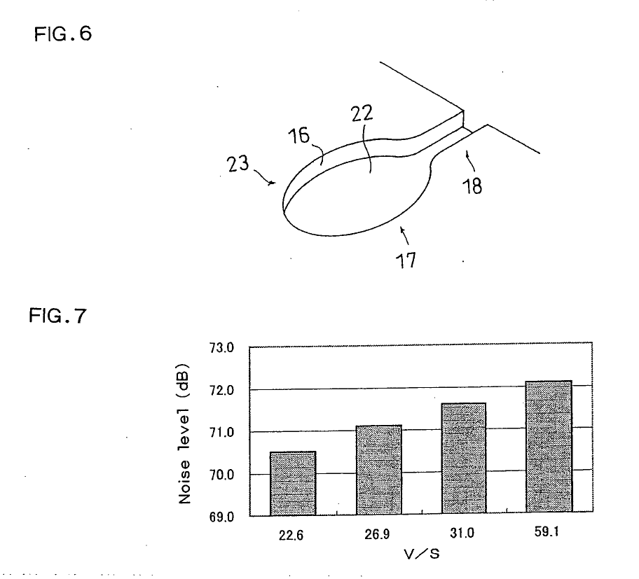

When a relation between a groove cross-sectional area S (mm²) in the minimum cross section 19 and a groove volume V (mm³) from the minimum cross section 19 to the groove head portion 17 when the projection 21 is not formed is V/S≧25, since the pumping sound is generated seriously as described above, the structure of the invention is especially effective. The groove volume when the projection 21 is not formed is a groove volume calculated using the groove bottom surface 22 when the projection 21 is not formed with the groove head portion 17 as shown in FIG. 6, or the like. When the groove neck portion 18 has a constant groove width and is in communication with the groove head portion or when there are a plurality of minimum cross sections 19, the groove volume V is calculated using one of the minimum cross sections 19 that is closest to the groove head portion 17.

It is preferable that a relation of the surface area a (mm²) of the projection 21 and a groove surface area A (mm²) from the minimum cross section 19 to the groove head portion 17 when the projection 21 is not formed is 0.01≦a/A≦0.5, and more preferably 0.02≦a/A≦0.4. If the relation a/A is less than 0.01, vibration of air in the substantially closed space formed between the groove head portion and the road surface is not absorbed by the projection 21 so much. If the relation a/A exceeds 0.5, since the projection 21 is increased in size with respect to the groove head portion 17, there is a tendency that the draining performance is deteriorated. The groove surface area when the projection 21 is not formed is an area calculated using the groove bottom surface 22, the inner wall 16 and the minimum cross section 19 when the groove head portion 17 is not formed with the projection 21 as shown in FIG. 6. When there are a plurality of minimum cross sections 19, the groove surface area A is calculated using one of the minimum cross sections 19 that is closest to the groove head portion 17.

### Second Embodiment

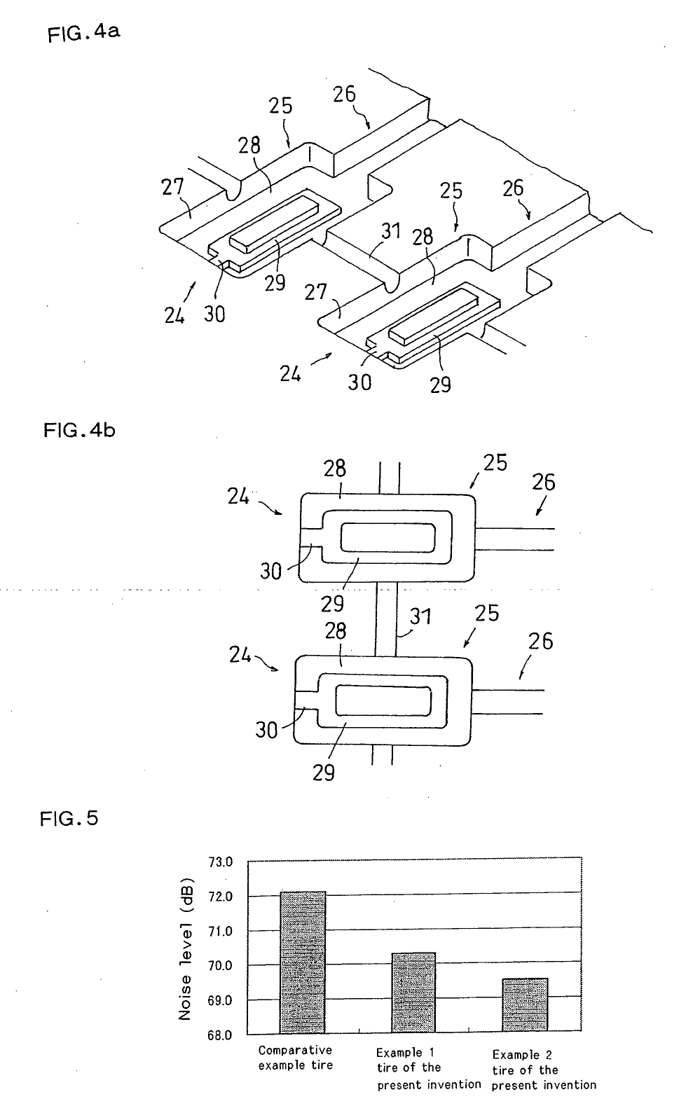

A second embodiment will be explained below. Portions of the second embodiment which are common to those of the first embodiment will not be repeated here, and different portions will mainly be explained. FIG. 4a shows an example of a tread surface of the pneumatic tire of the invention, and is a perspective view of a bag-like groove. FIG. 4b is a plan view of the bag-like groove.

As shown in FIGS. 4a and 4b, a bag-like groove 24 is formed into a bag-like shape whose groove width is locally increased at its end. The bag-like groove 24 includes a groove head portion 25 having a substantially loop-like partially opened inner wall 27, and a groove neck portion 26 which is in communication through a groove width smaller than a maximum groove width of the groove head portion 25. The groove head portion 25 is formed into a substantially rectangular shape as viewed from above, and another groove head portion 25 of another bag-like groove 24 is arranged on the other side with respect to a land portion.

A projection 29 rises from a groove bottom surface 28 of the groove head portion 25. The projection 29 is formed into a prism shape formed at its side with a step. By forming the step on the projection 29 in this manner, the surface area of the projection 29 can be increased, and vibration of air in the substantially closed space formed between the groove head portion 25 and the road surface is absorbed more effectively.

The groove head portion 25 is provided with a connecting portion 30 which connects the projection 29 and the inner wall 27 to each other. In FIG. 4a, the connecting portion 30 has the same land portion height as that of a lower step of the projection 29, but the land portion height of the connecting portion 30 is not limited to this. By providing the connecting portion 30, volume of air in the substantially closed space formed between the groove head portion 25 and the road surface can be reduced, the rigidity of the projection 29 can be enhanced, and the absorbing effect of vibration of air in the substantially closed space can be enhanced.

A connecting groove 31 extends such as to connect the groove head portions 25 of the bag-like grooves 24 to each other. With this, air in the substantially closed space formed between the groove head portion 25 and the road surface is dispersed from both of the groove neck portion 26 and connecting groove 31 and discharged out. As a result, pressure of air discharged through the groove neck portion 26 is reduced and thus, the pumping sound can be reduced more effectively.

It is preferable that a groove width of the connecting groove 31 is equal to or lower than the groove width of the minimum cross section and equal to or higher than 2 mm. If the groove width of the connecting groove 31 is less than 2 mm, necessary groove cross-sectional area through which air comes in and goes out in the connecting groove 31 can not be secured in grounding, and there is a tendency that the pumping sound reducing effect becomes small.

The groove depth of the connecting groove 31 is equal to or less than a land portion height of the block (groove depth of the groove head portion 25) and equal to or more than 20% of the land portion height. If the groove depth of the connecting groove 31 is less than 20% of the land portion height of the block, volume of air which is dispersed and discharged is small, and there is a tendency that the pumping sound reducing effect becomes small.

The connecting groove 31 is not limited to a groove extending straightly, and the connecting groove 31 may extend while curving. The connecting groove 31 is not limited to a groove having a constant groove width, and a groove width of the connecting groove 31 may be varied. In such a case also, it is preferable that the maximum groove width of the connecting groove 31 is equal to or smaller than a groove width of the minimum cross section and the maximum groove width is equal to or larger than 2 mm due to the above-described reason.

When the tread surface is formed with the connecting groove, the groove volume V should be a groove volume from the minimum cross section to the groove head portion when the connecting groove is not formed. The groove volume when the connecting groove is not formed is a groove volume calculated when the groove head portion 17 shown in FIG. 6 is not formed with the connecting groove.

### Other Embodiments

(1) The tread pattern formed on the tread surface of the pneumatic tire of the present invention is not limited to those shown in the previous embodiments only if the bag-like groove is formed, and the pattern pitch and shapes of the groove portion and land portion are not especially limited.

(2) The present invention is not limited to a case in which the lug groove is of bag-like shape as in the first embodiment. The invention can also be applied to a case in which a groove formed in a central portion of the tread is of bag-like shape. Although the groove head portion and the projection are of elliptic shape or rectangular shape as viewed from above in the previous embodiments, the groove head portion and the projection are not limited to those, and may be of gourd-shaped as viewed from above. The number of the projections is not limited to one, and one bag-like groove may be provided with a plurality of projections.

(3) The connecting groove is not limited to a groove which connects the groove head portions of the bag-like groove to each other as in the second embodiment, and the connecting groove may connect the groove head portion of the bag-like groove to another groove which is adjacent to that bag-like groove with a land portion interposed therebetween. The connecting groove may connect the groove head portion of the bag-like groove and the grounding end. The extending direction of the connecting groove is not especially limited, and the connecting groove may extend along the circumferential direction of the tire or may incline.

(4) When a plurality of bag-like grooves are formed in adjacent to one another in the circumferential direction of the tire, it is preferable that the connecting groove connects the groove head portions of the bag-like groove to each other, and it is preferable that the connecting groove extends along the circumferential direction of the tire. According to such a structure, substantially closed spaces are sequentially formed between the bag-like groove and the road surface as the tire rotates at the time of running, and pumping sound generated by the substantially closed spaces can efficiently be reduced.

### Example Tires of the Present Invention

To concretely show the structure and effect of the present invention, the noise-reducing performance was evaluated. The evaluation will be explained below. In the evaluation, a test on a single drum (JASO C606-81) was carried out using a test tire (tire size of LT265/75R16 10PR) under conditions of air pressure of 310 kPa, load of 6700N, rim of 16×8.5-JJ and speed of 80 km/h. In the evaluation on the drum, a noise level was measured using a microphone disposed at a height of 0.25 m at a location away from a center of the tire by 1 m. Each of the test tires had a tread surface formed with five kinds of bag-like grooves shown in Table 1.

TABLE 1

| | Bag- | Bag- | Bag- | Bag- | Bag- |
|---|---|---|---|---|---|
| | like | like | like | like | like |
| | groove | groove | groove | groove | groove |
| | 1 | 2 | 3 | 4 | 5 |
| Groove width w | 4.41 | 4.84 | 4.19 | 6.12 | 9.58 |
| (mm) | | | | | |
| Maximum groove width | 9.84 | 9.93 | 12.44 | 12.26 | 13.64 |
| (mm) | | | | | |
| Groove volume V | 4575.0 | 5036.1 | 4690.6 | 4916.4 | 3598.5 |
| (mm³) | | | | | |
| Groove | | | | | |
| cross-sectional | 60.0 | 65.8 | 57.0 | 83.2 | 115.9 |
| area S (mm²) | | | | | |
| W/w | 2.2 | 2.1 | 3.0 | 2.0 | 1.4 |
| V/S | 76.3 | 76.5 | 82.3 | 59.1 | 31.0 |

A comparative example tire has bag-like grooves provided no projections, an example tire 1 of the present invention has bag-like grooves provided with projections, and an example tire 2 of the invention has bag-like grooves provided with projections and connecting grooves. Each projection has d/D of 0.5 and a/A of 0.22. The connecting groove has a groove width of 4 mm which is smaller than a groove width of the minimum cross section, and a depth of 90% of the land portion height of the block. A result of the evaluation is shown in FIG. 5.

It can be found from a graph shown in FIG. 5 that the noise level of the example tire 1 of the present invention is lower than that of the comparative example. This is because that since the projection is formed on the groove head portion of the bag-like groove, the volume in the substantially closed space formed between the groove head portion and the road surface is reduced, and because that vibration of air in the substantially closed space is absorbed by the projection. The noise level of the example tire 2 of the invention is lower than that of the example tire 1. This is because that since the connecting groove is formed, air in the substantially closed space is dispersed and discharged.

1. A pneumatic tire having a tread surface formed with a groove portion, wherein the groove portion comprises a bag-like groove having a groove head portion where the groove portion has a substantially loop-like partially opened inner wall, a groove neck portion which is in communication with the groove head portion through a groove with smaller than a width of a maximum groove width of the groove head portion, the groove head portion of the bag-like groove is formed with a projection rising from a groove bottom surface.

2. The pneumatic tire according to claim 1, wherein when a cross section of the groove neck portion in which a groove cross-sectional area becomes minimum is defined as a minimum cross section, a relation between a groove cross-sectional area S (mm²) in the minimum cross section and a groove volume V (mm³) from the minimum cross section closest to the groove head portion to the groove head portion when the projection is not formed is V/S≧25.

3. The pneumatic tire according to claim 1, wherein when a cross section of the groove neck portion in which a groove cross-sectional area becomes minimum is defined as a minimum cross section, a relation between a surface area a (mm²) of the projection and a groove surface area A (mm²) from the minimum cross section closest to the groove head portion to the groove head portion when the projection is not formed is 0.01≦a/A≦0.5.

4. The pneumatic tire according to claim 1, wherein the projection is formed with a step.

5. The pneumatic tire according to claim 1, wherein the groove head portion is provided with a connecting portion which connects the projection and the inner wall of the groove head portion to each other.

6. The pneumatic tire according to claim 1, wherein a relation between a land portion height d (mm) of the projection and a land portion height D (mm) of a block is 0.15≦d/D≦0.75.

7. The pneumatic tire according to claim 1, further comprising a connecting groove which connects a groove or a grounding end which is adjacent to the bag-like groove through the land portion and the groove head portion of the bag-like groove to each other.

8. The pneumatic tire according to claim 7, wherein when the cross section of the groove neck portion where the groove cross-sectional area becomes minimum is defined as the minimum cross section, a groove width of the connecting groove is equal to or smaller than a groove width of the minimum cross section and equal to or larger than 2 mm.

9. The pneumatic tire according to claim 7, wherein a groove depth of the connecting groove is equal to or larger than 20% of a groove depth of the groove head portion.

10. A pneumatic tire having a tread surface which comprises:
a plurality of land portions;
groove portions dividing and defining the land portions, wherein the groove portions are comprised of lug grooves enclosed by inner walls and opened at a tread edge of the tread surface; and
projections each rising from bottom surfaces of the lug grooves.

11. The pneumatic tire according to claim 10, wherein each lug groove has a groove neck portion via which the lug groove is opened at the tread edge, wherein the lug groove constitutes a groove head portion, and the groove neck portion communicated with the groove head portion has a width smaller than a maximum groove width of the groove head portion.

12. The pneumatic tire according to claim 11, wherein the groove neck portion has a cross section satisfying V/S≧25, wherein S (mm²) is a minimum groove cross-sectional area in the groove neck portion, and V (mm³) is a groove volume of the groove head portion starting from a position of the minimum groove cross-sectional area closest to the groove head portion without considering the projection.

13. The pneumatic tire according to claim 11, wherein each projection has a surface area satisfying 0.01≦a/A≦0.5, wherein a (mm²) is a surface area of the projection, and A (mm²) is a groove surface area of the groove head portion starting from a minimum cross section of the groove neck portion closest to the groove head portion without considering the projection.

14. The pneumatic tire according to claim 11, wherein the projection has a step.

15. The pneumatic tire according to claim 11, wherein the groove head portion is provided with a connecting portion which connects the projection and the inner wall of the groove head portion to each other.

16. The pneumatic tire according to claim 11, wherein each projection has a height satisfying 0.15≦d/D≦0.75, wherein d (mm) is a height of the projection, and D (mm) is a height of the land portion.

17. The pneumatic tire according to claim 11, wherein the tread surface further comprises connecting grooves which connect the groove head portions adjacent to each other, said connecting grooves having a groove width equal to or smaller than a groove width of a minimum cross section of the groove neck portion.

18. The pneumatic tire according to claim 17, wherein when the groove width of the connecting grooves is equal to or larger than 2 mm.

19. The pneumatic tire according to claim 17, wherein the connecting grooves have a groove depth equal to or larger than 20% of a groove depth of the groove head portions.

20. The pneumatic tire according to claim 10, wherein the projections have generally or substantially the same shape as the lug grooves as viewed from top.

21. The pneumatic tire according to claim 10, wherein the tread surface further comprises lateral grooves extending from an outer side of the tire in its widthwise direction toward a center of the tread surface while curving, and thin grooves extending to connect the lateral grooves to each other and inclining with respect to a circumferential direction of the tire.
